(19) United States
(12) Patent Application Publication
(10) Pub. No.: US 2008/0084711 A1
(43) Pub. Date: Apr. 10, 2008

(54) Quick secure connection system for outdoor lighting systems

(75) Inventor: Chi Gon Chen, Gueng Zhou (CN)

Correspondence Address: STRASBURGER & PRICE, LLP, 901 MAIN STREET, SUITE 4400, DALLAS, TX, 75202, US

(73) Assignee: International Development Corp.

(21) Appl. No.: 11/784,495

(22) Filed: Apr. 6, 2007

Related U.S. Application Data
(60) Provisional application No. 60/850,365, filed on Oct. 6, 2006.

(51) Int. Cl. H01R 33/00

(52) U.S. Cl. 362/648

(57) ABSTRACT

A quick secure connection system for use with a set of outdoor lights includes a power source having a two-wired female connector surrounded by external threads. Threadably connected to the female connector on the power source is a male connector surrounded by an internally threaded collar. The male connector is mounted on one end of a power transmission cord.

On the opposite end of the power transmission is a two-wired light assembly. On the base of the two-wired light assembly is another two-wired female connector from which a set of outdoor lights may be assembled.

### CROSS REFERENCE TO RELATED APPLICATION

This application claims the benefit of Provisional U.S. Patent Application 60/850,365, filed Oct. 6, 2006.

### STATEMENT REGARDING FEDERALLY FUNDED RESEARCH AND DEVELOPMENT

This invention described in this patent application was not the subject of Federally sponsored research or development.

### FIELD

The present invention pertains to outdoor lighting systems; more particularly, present invention pertains to outdoor lighting systems typically used near walkways, driveways, gardens, flowerbeds, and the like where a set of individual outdoor lights are electrically connected one to another by a power cord.

### BACKGROUND

In recent years, it has become common for home owners to add outdoor lighting systems to areas surrounding or extending from their residences. Many home owners use outdoor lighting systems to provide illumination of footpaths leading from entrances. Other home owners use a set of outdoor lights to mark driveways. Still other home owners use outdoor lighting to provide a unique effect in a flower bed or near shrubs. And still others use outdoor lighting to border a patio or an outdoor living space.

The outdoor lighting products that most are familiar to homeowners include a set of low voltage lights wherein each low voltage light is enclosed within a decorative housing, a transformer which reduces the voltage of house current to the level of the of the low voltage bulbs in each fixture, and a power cord extending from the transformer to each of the individual outdoor lights. The power cord is generally buried in the soil between each light fixture.

In some new sets of outdoor lighting products a single solar panel assembly is used to gather light energy during daylight hours and transform the light energy into electrical energy. The electrical energy is stored in a battery until needed typically during the early evening hours. When desired, the stored electrical energy is directed from the battery to the individual outdoor lights using a power cord.

To provide maximum flexibility for placement of individual light fixtures, many sets of low voltage lights include pin connectors. The pin connectors may be placed at selected locations along the power cord. Such pin connectors include a split housing. Inside the split housing are pins which are connected to the electrical leads for each light source. The power cord is placed within the split housing when the split housing is open at the location along the power cord where the light fixture is to be placed. The split housing is then closed and the pins within the split housing are used to pierce the insulation on the power cord to make an electrical connection with the metal wires located under the insulation within the power cord.

Those who have attempted to set up an outdoor lighting system using pin connectors with a split housing have often experienced the frustration of not making the desired electrical connection between the pin and the metal wires after the split housing has been closed around the power cord. In such cases, it is necessary to re-open the split connector and attempt to create another piercing of the insulation portion of the power cord with the pins located inside the pin connector. Since the insulation around the power cord is generally not self sealing, a small opening will be left in the insulation by the prior failed attempt to make an electrical connection. Such small opening in the insulation is potentially dangerous if the light fixture and power cord are placed in moist soil.

Even if a successful electrical connection is made by the second piercing of the insulation with the pins inside the pin connector, the electrical connector is not sealed and remains open to the corrosive effects of moisture and the chemicals in the soil. Thus some home owners have found that while the lighting system using pin connectors may operate properly for several months, it will fail prematurely because of corroded wires within the power cord.

Some home owners have experienced the frustration of having one outdoor fixture in a string of outdoor fixtures fail. The solution is to remove the failed light fixture and replace it with another light fixture. However, replacing a light fixture using prior art pin connectors leaves more holes in the insulation and a greater chance for moisture and the corrosive elements contained within the soil to attack the metal wires in the power cord.

Yet other homeowners desire to change out the styles of light fixtures being used. Such change requires removing the old light fixtures and replacing them with new ones. As in the previous situation, changing out styles of light fixtures may eventually destroy the insulation around the power cord and cause corrosion of the metal wires within the power cord.

Accordingly, there remains a need in the art for a more secure connection system that is usable with outdoor lighting systems used along walkways, driveways, flower beds, patios and the like which provides for rapid, secure connection between light fixtures.

### SUMMARY

The present invention relates to a quick secure connection system that is usable with outdoor lighting system including a small group of individual light fixtures.

The disclosed quick secure connection system for outdoor lighting systems includes an externally threaded female electrical connector attached to a power source and to the base of each light fixture. Connecting a light fixture in the string of light fixtures to the power source and to the remaining light fixtures is a power cord having a male electrical connector on one end. The male electrical connector is surrounded by an internally threaded collar which is threadably engaged with the external threads surrounding the female electrical connector.

### BRIEF DESCRIPTION OF THE DRAWING FIGURES

A still better understanding of the quick secure connection system for outdoor lighting systems of the present invention may be had by reference to the drawing figures wherein:

FIG. 1A is a perspective view of an outdoor light system designed for use with house current including a transformer and employing the quick secure connection system of the present invention;

FIG. 1B is a perspective view of an individual light fixture taken from FIG. 1A including an exploded view of the quick secure connection system of the present invention;

FIG. 1C is an enlarged perspective view of a light fixture with an assembled quick secure connection taken from FIG. 1A;

FIG. 2 is a perspective view of a transformer and the base of the pole portion of a light fixture including the disclosed invention in an unconnected state;

FIG. 3 is a perspective view similar to FIG. 2 but where the disclosed invention is in a connected state with the transformer;

FIG. 4 is a perspective view of an outdoor light system similar to that shown in FIG. 1A but including an additional power cord segment.

FIG. 5A is a top perspective view of a light fixture usable with an outdoor light system having a set of solar panels affixed thereto;

FIG. 5B is a bottom perspective view of the set of solar panels shown in FIG. 5A;

FIG. 6 is a perspective view of an outdoor light system using a solar panel set shown in FIG. 5A and employing the quick secure connection system of the present invention;

FIG. 7 is a front elevational view of an amorphous double junction solar panel connected to a snowflake fixture using the quick secure connection system of the present invention.

### DESCRIPTION OF THE EMBODIMENTS

The disclosed invention is designed for use with outdoor lighting systems whether powered by house current run through a transformer or powered by solar panels.

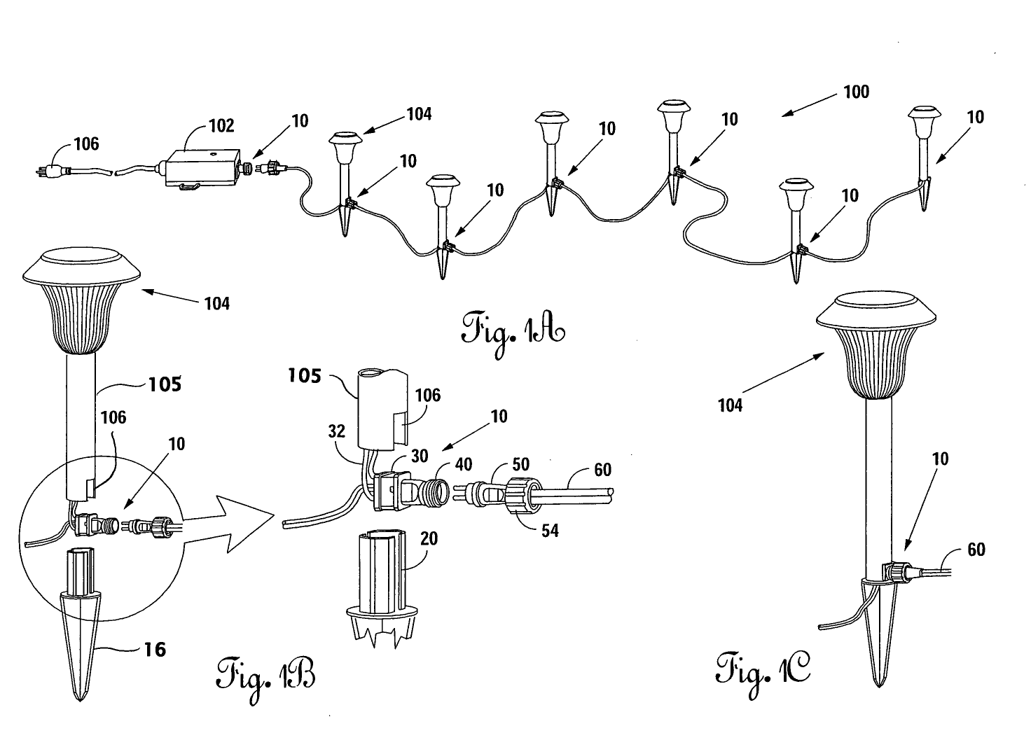

As may be seen in FIG. 1A, the outdoor lighting system 100 in which the disclosed invention is included is designed to use a standard plug 106 which connects to an outlet for 120 v AC house current. The 120 vAC house current is reduced in voltage with a transformer 102. As will be shown in FIGS. 1B and 1C, the quick secure connection system 10 of the present invention is used to make a power output connection with the transformer 102.

The low voltage electrical output of the transformer 102 is then supplied to a plurality of outdoor light fixture assemblies 104 which may be placed at various locations as desired. As shown in FIG. 1B at the bottom of each light fixture light fixture assembly 104 is a ground stake 16. The ground stake 16 is used to hold the light fixture in place by pressing it into the soil in a garden, lawn, flower bed or the like. As shown in FIG. 1A, the quick secure connection system 10 of the present invention is used on each light fixture assembly 104 and on the transformer 102.

In FIG. 1B an enlargement of the quick secure connection system 10 of the present invention is shown. Just above where the pole portion 105 of the light fixture assembly engages the ground stake 16 a small substantially rectangular opening 106 is formed in the bottom of the pole 105 to accommodate the mounting for the female electrical portion 40 quick secure connection system 10 of the present invention. At the top of the ground stake 16 is receiver 20. The mounting block which fits into the receiver 20 both contains the wires 32 to the lamp in the light fixture assembly 104 and provides a base for and the female electrical connector 40. The size of the mounting block 30 is such that the hollow pole 105 will slide over both the housing 30 and the receiver 20 such that the female electrical connector 40 of the quick secure connection system 10 extends outwardly from the pole 105 through the rectangular opening 106. A connection is then made with the prongs in the male electrical connector 50 of the quick secure connection system 10 by placing the prongs 52 on the male electrical connector 50 into the openings 42 of the female electrical connector 42 and threadably connecting the internal threads within the collar 54 surrounding the male electrical connector 50 with the external threads 44 surrounding the female electrical connector 40 of the connection system 10. A completed connection with an outdoor lamp appears in FIG. 1C.

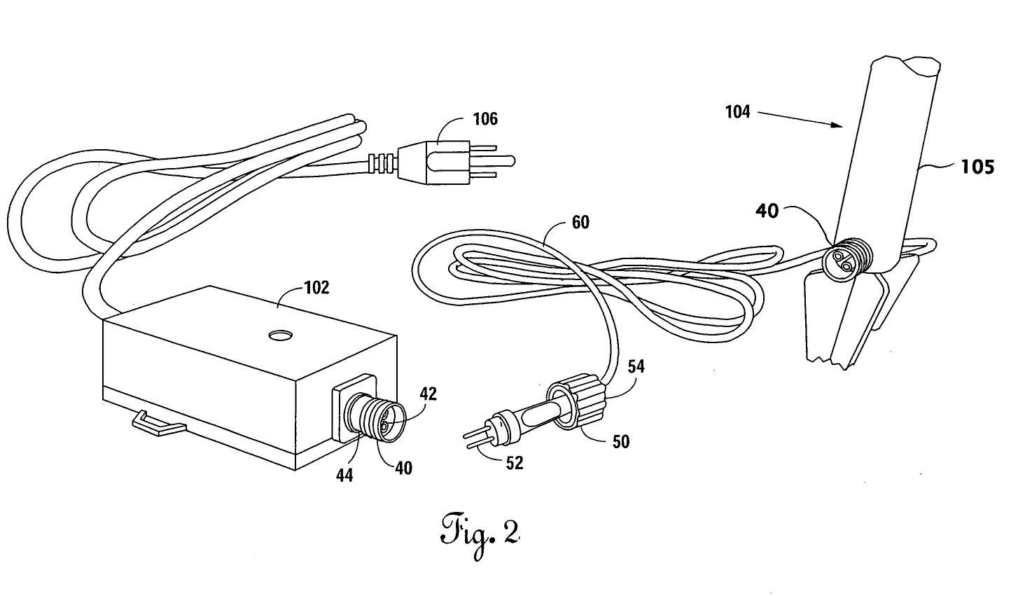

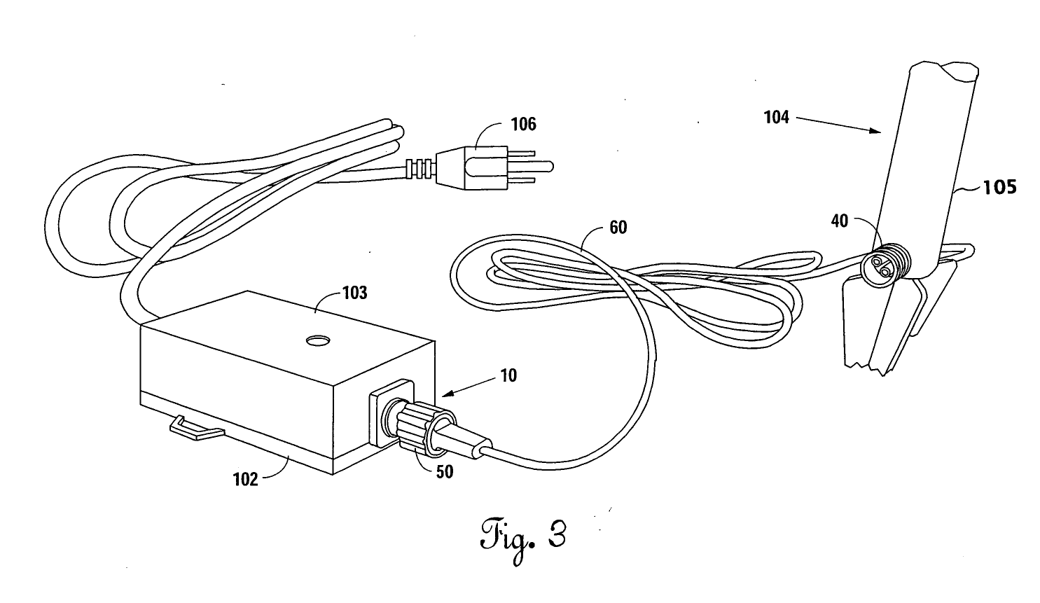

A still better understanding of the present invention made be had by reference to FIG. 2 and FIG. 3. Therein, the transformer 102, which may be plugged into house current with a typical three prong grounded plug 106, is shown. Connected to the transformer 102 is a female electrical connector 40 surrounded by external threads 44.

The male electrical connector 50, shown in FIG. 2, is in close proximity to the female electrical connector 40 with the internally threaded collar 54 of the male electrical connector 50 pulled back to show the prongs 52. A wire 60 exits the back of the male electrical connector 50 and passes into the first light fixture assembly 104 to provide power to whatever lamp or LED is used on top of the pole 105 of the light fixture assembly 104. To enable the connection to subsequent light fixture assemblies 104, a female connection 40 is shown at the base of the pole 105 of a light fixture assembly 104.

As may be seen in FIG. 2 and in FIG. 3, the open female electrical connector 40 on the lamps will allow for the connection of another light fixture assembly 104.

Some home owners may desire to use a spot light assembly to illuminate a house number when visitors are expected or to illuminate a holiday decoration such as a wreath on a door. In such cases there may be a need to add a spot light assembly intermittently to a set of outdoor lights between similar light fixture assemblies 104. In such situations, a tee-type fitting may be added to the power cord 60 between the light fixture assemblies 104 to allow for the intermittent addition of a spotlight assembly. Those of ordinary skill in the art will understand that the tee-type fitting will typically include two female electrical connectors 40 and one male electrical connector 50.

Alternatively an ornate or decorative lighting fixture assembly may be desired for holiday decorations or decorations for a special event such as a wedding reception. By use of the quick secure connection system 10 of the present invention the home owner may be able to change out lighting fixture assemblies without the use of special tools.

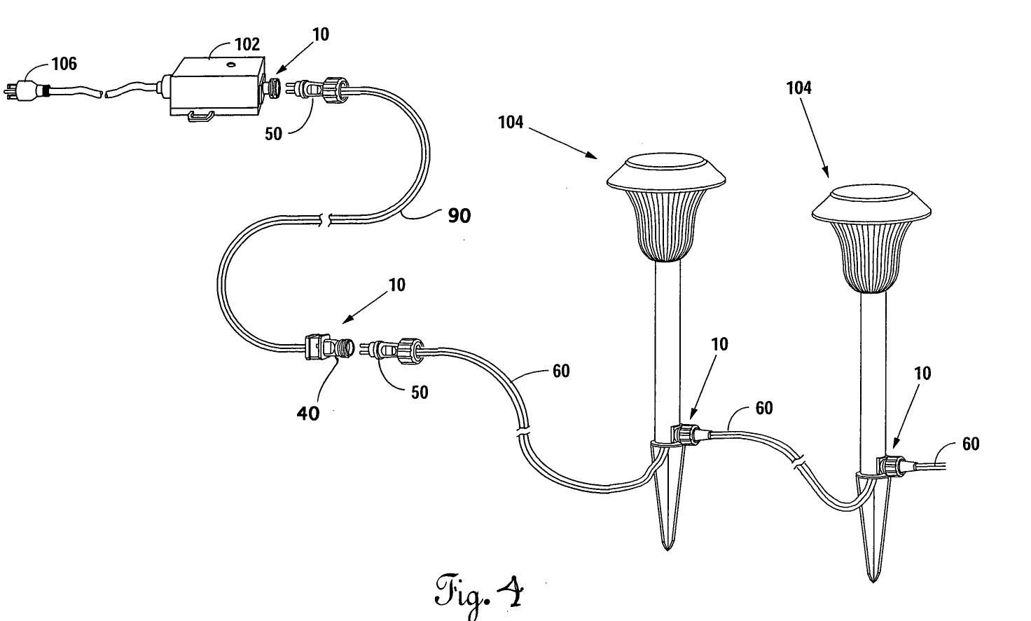

In yet other situations and as shown in FIG. 4, it may be necessary to place lights 104 an extended distance apart. In the preferred embodiment the home owner is supplied with an approximately 8 foot length of power cord between lighting fixture assemblies 104. Alternatively, for situations where the light fixture assemblies 104 are to be placed apart from one another at greater distances, a 12 foot or a 16 foot length of power cord may be used. In yet other situations, an extender cord 90 with a female electrical connector 40 on one and a male electrical connector 5 on the other end as shown in FIG. 4 may be used.

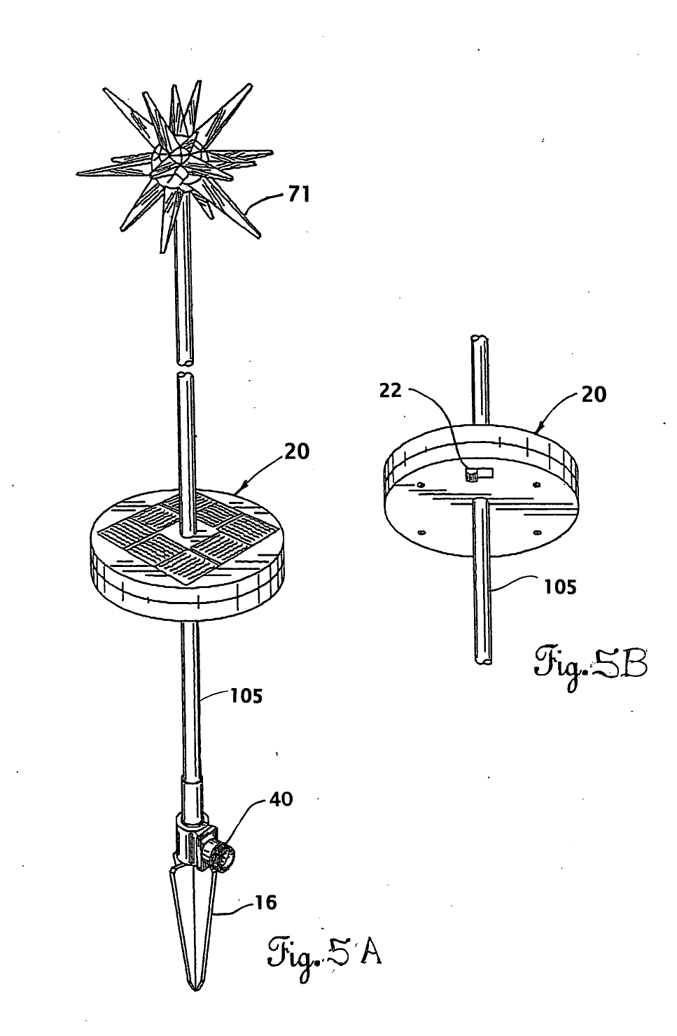

As previously indicated, power may be supplied from a set of solar panels which transform light energy into electrical energy. Shown in FIG. 5A is a set of solar panels affixed to the mounting pole 105 of a decorative light fixture including a Moravian star 71. The electrical energy needed is stored in a battery contained within the housing for the set of solar panels 20. Activation of the system occurs by moving the on-off switch 22 shown in FIG. 5B.

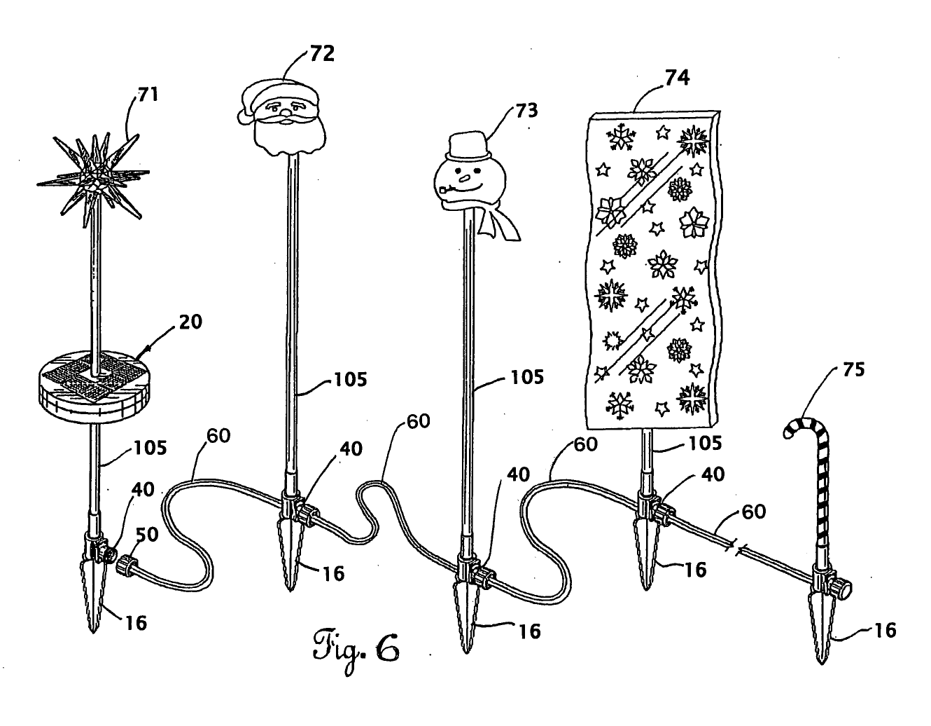

In FIG. 6 the set of solar panels 20 is shown with a variety of different decorative holiday fixtures 104 including a variety of tops 71, 72, 73, 74, and 75. Typically, when a set of solar panels 20 is used the light source used within each light fixture is an LED or an array of LED's.

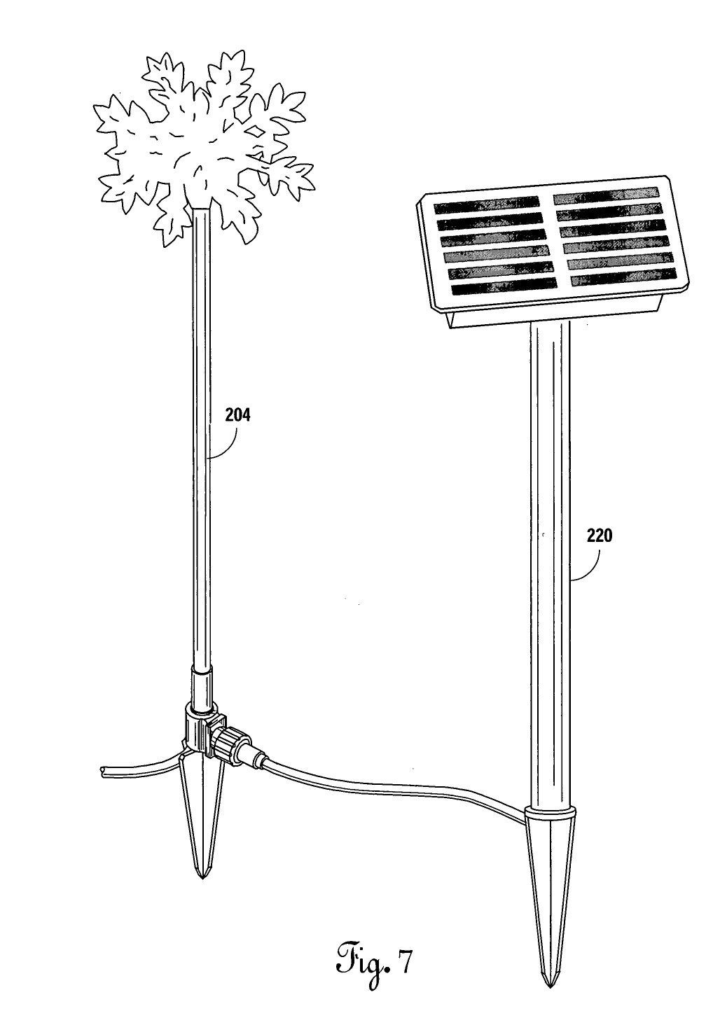

In FIG. 7 is an amorphous double junction solar panel 220 attached to a snowflake holiday fixture 204. The single amorphous double junction solar panel 220 will produce sufficient electrical power for a set of up to six lights.

While the present invention has been disclosed according to its preferred and alternate embodiments, those of ordinary skill in the art will understand that numerous other embodiments have been enabled such other embodiments shall be included within the scope and meaning of the appended claim.

What is claimed is:

1. A quick secure connection system for a set of outdoor lights connected to a power source, said quick secure connection system comprising:
a pair of wires extending from the light source in each light in the set of outdoor lights;
a female connector constructed and arranged for mounting in each of the outdoor lights, said female connector being electrically connected to said pair of wires;
said female connector being surrounded by an externally threaded housing;
a male connector constructed and arranged for interfitment with said female connector electrically connected to power cord;
an internally threaded collar surrounding the power cord and the male connector;
whereby electrical connection of each light in the set of outdoor lights is made by interfitment of said male connector into said female connector and threadable engagement of said internally threaded locking piece with said externally threaded housing.

2. A set of outdoor lights comprising:
a two-wired electrical power source;
a first two-wired female connector surrounded by external threads attached to said two-wired electrical power source;
a first two-wired male connector surrounded by an internally threaded collar attached to an electrical power transmission cord;
a first two-wired electrical light attached to the opposite end of said electrical power transmission cord from said first two-wired male connector;
a second two-wired female connector surrounded by external threads attached to said first two-wired electrical light;
a second two-wired male connector surrounded by an internally threaded collar attached to an electric power transmission cord;
a second two-wired electrical light attached to the opposite end of said electrical power transmission cord from said second two-wired male connector;
whereby threadable connection of said first two-wired female connector with said first two-wired male connector will provide electrical power to said first light and threadable connection of said second two-wired female connector with said second two-wired male connector will provide electrical power to said second light.

3. The set of outdoor lights as defined in claim 2 wherein said two-wired electrical power source is a transformer.

4. The set of outdoor lights as defined in claim 2 wherein said two-wired electrical power source is a set of solar panels.

5. The set of outdoor lights as defined in claim 2 further including:
a T-shaped electrical connection in said power cord,
said T-shaped connection including two-wired female connectors surrounded by external threads;
a third two-wired electrical light having a power cord with a two-wired male connector surrounded by an internally threaded collar
whereby said third two-wired electrical light branches off said power cord.

6. The set of outdoor lights as defined in claim 2 further including an extension power cord section having a two-wired female connector surrounded by external threads on one end on a two-wired male connector surrounded by an internally threaded collar on the opposite end.

7. A method for creating a set of outdoor lights compromising the steps of:
mounting a two-wired female connector surrounded by external threads to a power source;
mounting a two-wired male connector surrounded by a collar having internal threads to one end of a first power transmission cord;
mounting a first two-wired light to the second end of said first power transmission cord,
mounting a two-wired female connector surrounded by external threads to said first two-wired light;
mounting a two-wired male connector surrounded by a collar having internal threads to one end of a second power transmission cord;
mounting a second two-wired light to the second end of said power transmission cord.

8. The method as defined in claim 7 wherein said power source is house current passing through a transformer.

9. The method as defined in claim 7 wherein said power source is a set of solar panels.
